(19) United States
(12) Patent Application Publication
(10) Pub. No.: US 2021/0097584 A1
(43) Pub. Date: Apr. 1, 2021

(54) GENERATING IMPLICIT RATINGS FOR VIDEO GAMES USING EXTERNAL METADATA

(71) Applicant: NINTENDO CO., LTD., Kyoto (JP)

(72) Inventors: Sharad Ranjan, Redmond, WA (US); David Tran, Sammamish, WA (US)

(21) Appl. No.: 16/586,649

(22) Filed: Sep. 27, 2019

(51) Int. Cl. G06Q 30/02; A63F 13/79; A63F 13/77

(52) U.S. Cl. CPC G06Q 30/0282; A63F 2300/5546; A63F 13/77; A63F 13/79

(57) ABSTRACT

In certain example embodiments, a computer system for generating an implicit video game rating is provided. The system generates a base rating that is a function of gameplay data for a specific user and other users. The system also generates an average external rating for the video game based on external data categories such as, user reviews, critic reviews, ownership data, etc. An adjustment factor is then calculated from an average base rating and external rating and then applied to the user's individual base rating to obtain an implicit rating of a video game for the user.

### CROSS REFERENCE(S) TO RELATED APPLICATIONS(S)

Not applicable

### TECHNICAL OVERVIEW

The technology described herein relates to techniques for implicitly generating ratings for software products, such as video games. More particularly, the technology described herein relates to using external data sources in combination with user specific metadata regarding how a video game has been played to automatically generate an implicit rating for the video game.

### INTRODUCTION

Video games are a popular activity enjoyed by many. There are thousands of different video games available for consumers that are split into many different genres, types, features, and the like. Different people have different preferences regarding the likes and dislikes for the games they play. One person may like strategy games instead of sports games. Another may prefer multiplayer games over single player games. Information on what games a person likes (or what they don't like) can be helpful is assessing what new games (or old, but undiscovered games) may be a good fit for a particular person. Indeed, with an ever-increasing number of video games available it can be difficult for people to find games that they will like as new (and old) games can be overlooked in large catalogs of possible games.

Accordingly, it will be appreciated that new and improved techniques, systems, and processes are continually sought after in this and other areas of technology.

### SUMMARY

In certain example embodiments, a computer system is provided for generating implicit, user-specific/personalized ratings for video games that are played by users. The computer system stores or accesses a plurality of gameplay data records that are based on how a plurality of users have interacted with at least a first video game. The computer system stores or accesses a plurality of external source data records that each correspond to at least one external source that references the first video game. The computer system includes at least one hardware processor of a processing system and generates a community average for the first video game that is based on the plurality of gameplay data records and how each one of the plurality of users has interacted with the first video game. A base rating is calculated for a first user and the first video game as a function of the gameplay data record of the first user and the generated community average. A plurality of external ratings for the first video game are calculated, with each being based on at least one of the external source data records. An external average is generated by combining the plurality of external ratings with a plurality of respective weights. An adjustment value is generated as a function of the generated external average and a generated base rating for the first video game that is based on the plurality of users that have interacted with the first video game. An implicit rating is derived for the user and the video game by adjustment of the base rating for that user by using the generating adjustment value.

This Summary is provided to introduce a selection of concepts that are further described below in the Detailed Description. This Summary is intended neither to identify key features or essential features of the claimed subject matter, nor to be used to limit the scope of the claimed subject matter; rather, this Summary is intended to provide an overview of the subject matter described in this document. Accordingly, it will be appreciated that the above-described features are merely examples, and that other features, aspects, and advantages of the subject matter described herein will become apparent from the following Detailed Description, Figures, and Claims.

### BRIEF DESCRIPTION OF THE DRAWINGS

These and other features and advantages will be better and more completely understood by referring to the following detailed description of example non-limiting illustrative embodiments in conjunction with the drawings of which:

FIG. 1 shows an architecture diagram that includes an example rating computer system according to certain example embodiments;

FIG. 2 includes multiple graphs that illustrate different possible distributions for how video games may be rated according to certain example embodiments;

FIG. 3 is a graph that illustrates average playtime for an example game according to certain example embodiments;

FIGS. 4A and 4B include graphs that illustrate different relationships between play time distribution and rating distribution;

FIG. 5 is a process for generating a user specific implicit rating for a video game according to certain example embodiments;

FIG. 6 illustrates how example generated adjustment factors may shift the distribution of ratings for a given game; and

FIG. 7 shows an example computing device that may be used in some embodiments to implement features described herein.

### DETAILED DESCRIPTION

In the following description, for purposes of explanation and non-limitation, specific details are set forth, such as particular nodes, functional elements, techniques, protocols, etc. in order to provide an understanding of the described technology. It will be apparent to one skilled in the art that other embodiments may be practiced apart from the specific details and examples described below. In certain instances, detailed descriptions of well-known methods, systems, devices, techniques, etc. are omitted so as not to obscure the description with unnecessary detail.

Sections are used in this Detailed Description solely in order to orient the reader as to the general subject matter of each section; as will be seen below, the description of many features spans multiple sections, and headings should not be read as affecting the meaning of the description included in any section.

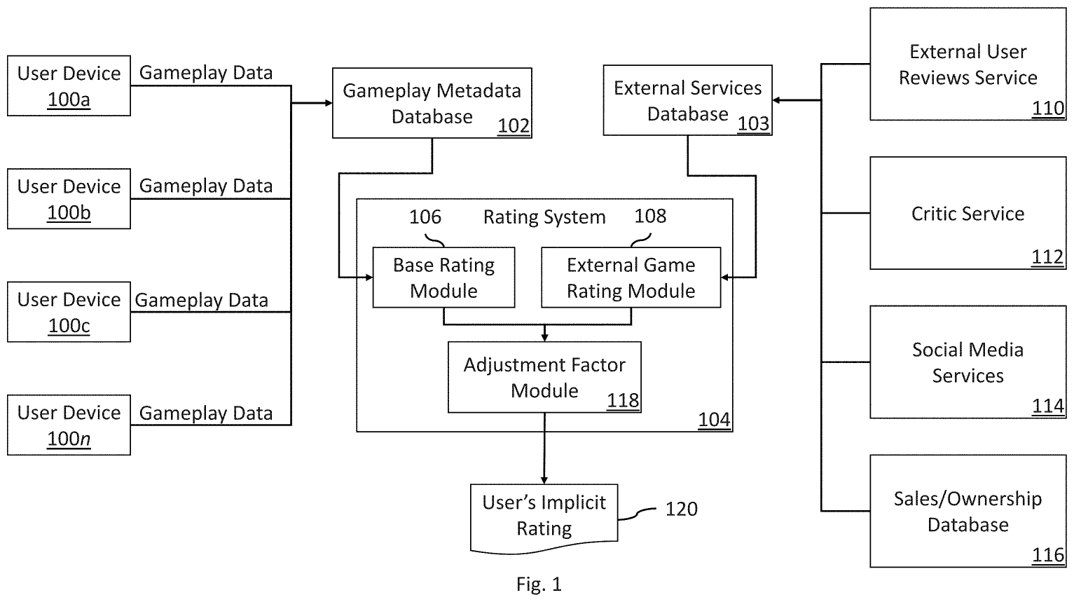

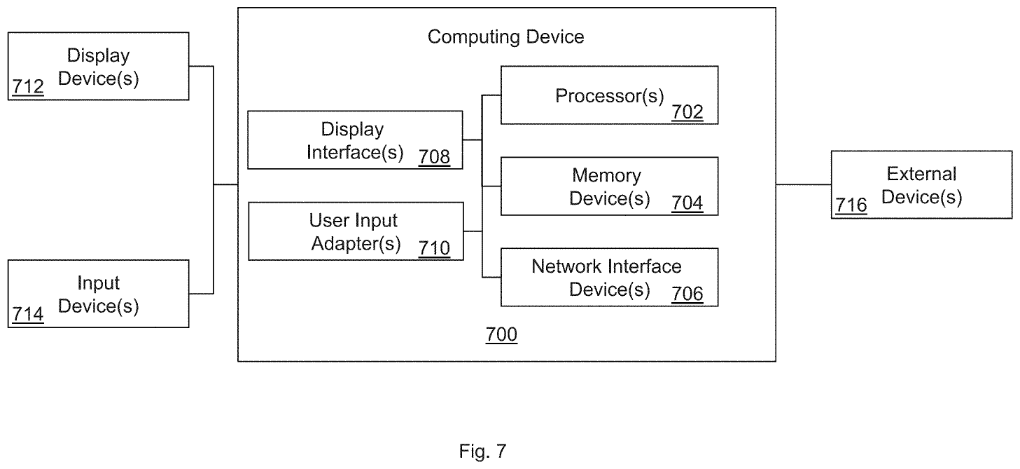

In many places in this document, including but not limited to the description of FIG. 1, software modules, software components, software engines, and/or actions performed by such elements are described. This is done for ease of description; and it should be understood that, whenever it is described in this document that a software module or the like performs any action, the action is in actuality performed by underlying hardware elements (such as a processor, hardware circuit, and/or a memory device) according to the instructions that comprise the software module or the like. Further details regarding this are provided below in, among other places, the description of FIG. 7.

### Overview

In certain example embodiments, a system for generating implicit ratings for video games that a user has played is provided. An implicit rating may be different from an explicit rating in that explicit ratings are those expressly provided by a user for rating a game. For example, an explicit rating may be a thumbs up or thumbs down input that a user provides in response to a query on a website or the like. In other instances, a user may write a review and leave a rating of, for example, between 1 and 5 (with 1 being a bad score and 5 being a good score). In other examples, non-numerical input may be provided by a user (e.g., “like it,” loved it,” “neutral,” “didn't like it,” and “hated it.”) as an explicit rating.

Implicit ratings, in contrast to explicit ratings, may be generated based on other data where a user does not actively provide a “rating” for a given video game. This may be based on, for example, observed behaviors or the like of the user in how they interact with the video game. Using such observed behaviors, an implicit rating for a given video game may be automatically generated without having the user explicitly provide such a rating. In certain example embodiments, this implicit rating may then be modified according to a calculated adjustment factor that is based on external data regarding the game in question. In certain example embodiments, an implicit rating may thus be generated based on the above observed behaviors for that user, the averages for how other users have played the same video game, and external data retrieved from external sources.

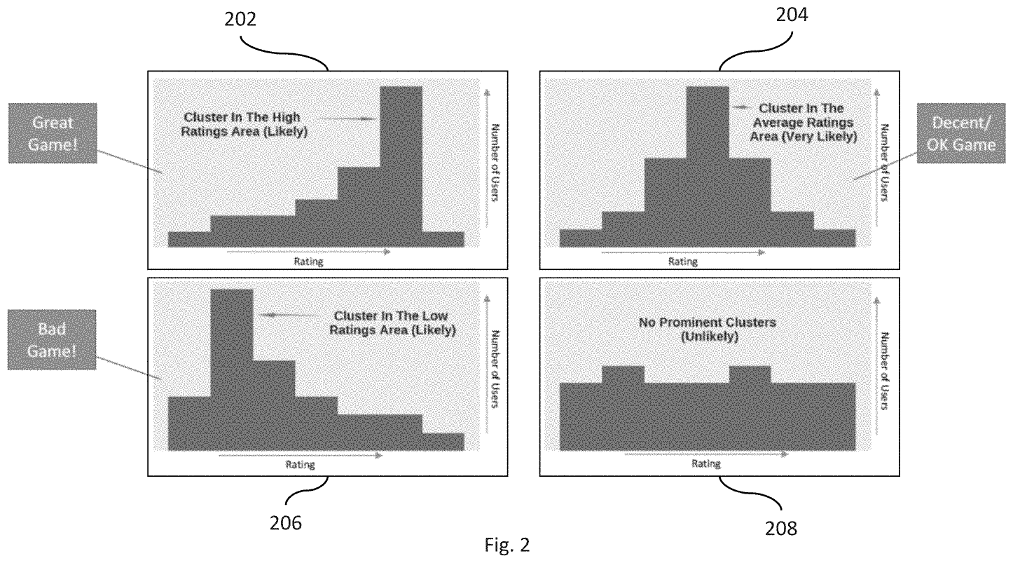

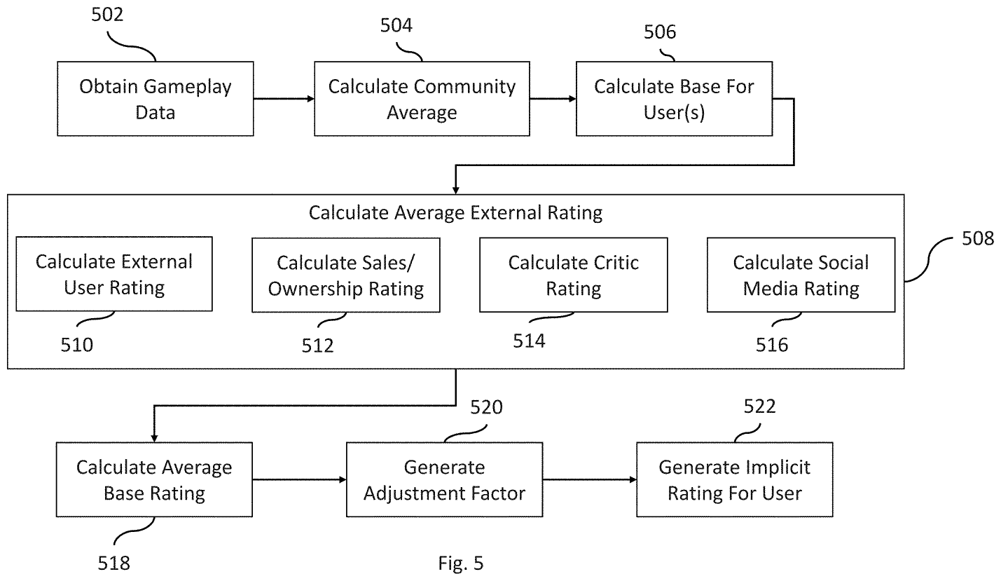

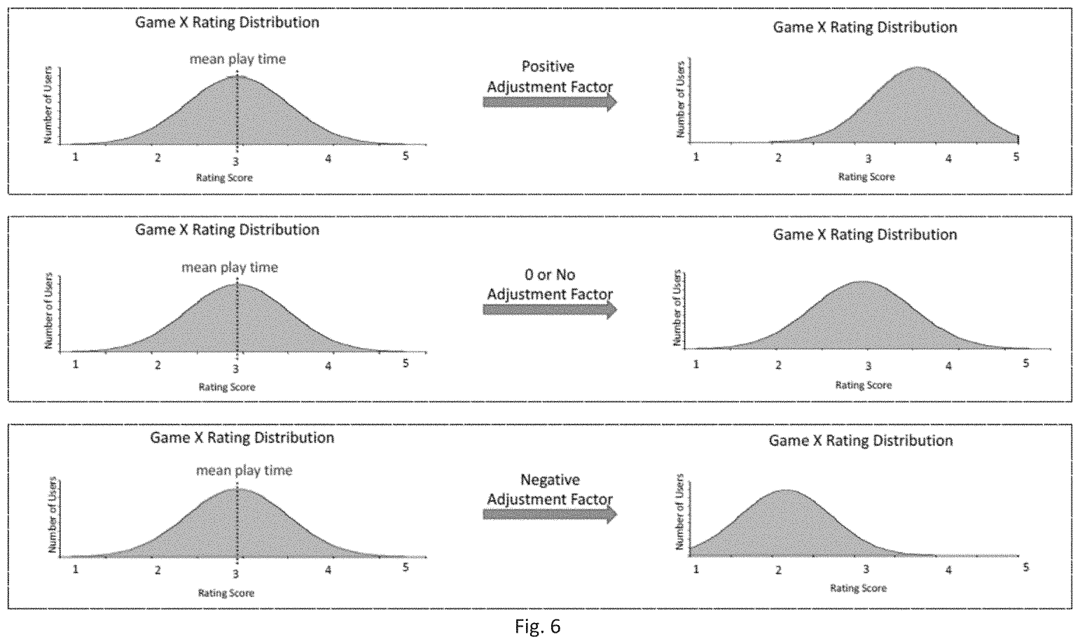

FIG. 1 is an architecture diagram of an example computer system that generates implicit ratings based on a combination of gameplay data for a video game and data from external sources regarding the video game. FIGS. 2, 3, 4A and 4B illustrate how example ratings for video games may vary and how such ratings may relate to gameplay data, such as the amount of time played in a video game. FIG. 5 illustrates a process that may be implemented on the rating computer system in FIG. 1 to generate implicit ratings for video games played by users. FIG. 6 shows how the distribution for game ratings may be shifted by using exemplary generated adjustment factors. FIG. 7 shows an example computing device that may be used in some embodiments to implement features described herein, such as those discussed in connection with FIGS. 1 and 5.

### Description of FIG. 1

FIG. 1 shows an architecture diagram that includes an example rating computer system 104 according to certain example embodiments.

The system shown in FIG. 1 includes user devices 100a-100n that each communicate, directly or indirectly, gameplay data to gameplay metadata database 102. External services database 103 stores data from external sources (or data that is derived or based on data from such sources). External user reviews service 110, critic service 112, social media services 114, and/or sales/ownership database 116 each communicate or otherwise provide data to external services database 103.

Rating system 104 may then access databases 102 and 103 to obtain the data stored therein and subsequently generate a user's implicit rating 120 for a given video game. Accordingly, a user specific rating for a specific video game can be generated based on observed behaviors of that user, other users, and external data provided from other sources. As discussed herein, the implicit rating 120 may then be used as input for a game recommendation engine that generates recommendations of other video games that the user may like.

User devices (also called game devices herein) 100a, 100b, 100c, and 100n are computing devices that execute video games (e.g., software programs) that are played by in association with a user of that computing device. User devices 100a-100n may be referred to herein as user device(s) 100 (one or more of user devices 100a-100n). User device 100 may also be called a game device. Note that while the term “game” device may be used in connection with certain example embodiments, this is done for ease of use and any type of computing device may be used. Indeed, a “game” device as used herein may be a computing device (e.g., a mobile phone, tablet, home computer, game console, etc.) that is being used (or will be used) to play a video game.

Game device 100 is an example of computing device 700 that is described in connection with FIG. 7. A non-limiting illustrative list of computing devices may include, for example, a smart or mobile device (e.g., a smart phone, a portable game console), a tablet computer, a laptop computer, a desktop computer, a home console system, a video game console system, a home media system, and other computer device types. As explained in connection with FIG. 7 computers can come in different sizes, shapes, functionality and the like.

Game device 100 may include different CPU and/or GPU architectures. For example, game device 100a may have an Intel CPU architecture (e.g., x86) and game device 100b may have an ARM architecture. In certain examples, the processing capabilities provided by the CPU, memory components, GPU, and/or other hardware components that make up a given game device may be different between game devices. Thus, for example game device 100c may be more “powerful” than game device 100b (e.g., in terms of potential processing throughput). In certain example embodiments, the type (or size) of display screen (e.g., a smaller display screen from a mobile device versus a larger monitor coupled a desktop computer or a television coupled to a home video game console). In certain examples, the type or size of input device may be different. For example, a mobile device may use a touch screen to provide input to a game whereas a desktop computer system may use a keyboard and mouse or a home console may use a video game controller. In certain example embodiments, a game device may use cloud-based computing resources (e.g., CPUs, memory device, and/or GPUs that are hosted in a cloud-based computing environment) to execute a game program. The results of that execution by the cloud-based computing resources (e.g., game images, etc.) may then be continuously sent to the game device that is being used by a user and presented thereon. Conversely, input that is provided by a user to such devices may be transmitted to the cloud-based computing resources and used as input for game processing that is performed thereon. Further details of different components that may be found in various game devices are discussed in connection with FIG. 7.

As shown in FIG. 1, game device 100 communicates gameplay data from each game device 100 to a gameplay metadata database 102. In certain example embodiments, the gameplay data may be communicated from other devices besides game devices. For example, a server that is used by the game devices may communicate such gameplay data. For example, in a MMORPG, the servers may communicate, for example, the gameplay times for when a user (e.g., their gameplay account) have accessed the game via the server.

In certain example embodiments, the term “user” includes each game device 100. In other words, the gameplay data may be associated with the game device (e.g., via a device identifier) on which the game is played rather than any specific person. Further, the term user as used herein includes association with a specific person, a specific device, a group of people, a group of devices, and/or an account, or the like. Thus, for example, people who play video games on user device(s) 100 may authenticate to a service with an account (e.g. the “user”) for that service. The account may be used on different ones of the user devices 100 by different persons. Thus, the game play data that is provided to database 102 may then be tied to that account—even if in actuality different devices and/or different persons are playing on that same account. In certain example embodiments, the gameplay data may be stored in association with a “user profile” or the like and multiple user profiles may be associated with a given account. For example, Jake and Mary (brother and sister) may have different user profiles for an account that is associated with their mother (who has another user profile). Each person may use a specific game device (or different game devices) to play different video games that are then stored in association with the current user context that is executing a given video game. Thus, an implicit rating for Jake for game X may be 3 while an implicit rating for Mary for game X may be 5—even though they both played the same game on the same device. In any event, gameplay data may be stored in association with a “user” and be used to generate an implicit rating of a video game for that “user.”

Gameplay metadata database 102 may be provided as part of rating system 104 and/or another computing device 700 as is described in connection with FIG. 7. For example, gameplay metadata database 102 may be an example of external service 716. In certain example embodiments, gameplay metadata database 102 may be provided via cloud-based computer environment such as, for example, Amazon S3 or other similar cloud-based computing functionality.

In certain example embodiments, gameplay data may include data regarding observed behaviors of how a given user has interacted with or otherwise used a specific video game. Thus, certain types of gameplay data may be associated with a given user, and a given game. For example, gameplay data may include a total time played by that user for a given game. Other gameplay data may include, for example, a number of times a user has played (e.g., started) a given video game. This may be, for example, recorded as a number of sessions a user has operated the game for. This data may be represented as a just a number (e.g., 50), or some other metric that represents how frequently, and/or how long each play session lasts. Thus, data that a user has played the same game for 2 hours each night over the past two months may be recorded. Other types of gameplay meta data may include, for example, 1) the number of games purchased or owned by a user; 2) a number of games played; 3) a breakdown of the types of games played by a user (e.g., multiplayer or single player, strategy or fighting games, etc. . . . ); 4) the types of achievement has unlocked for the video game; 5) the progress a user has made through a video game (e.g., what level they are on, how much of the game has been completed, which may be presented by a number and/or percentage of completion); 6) types of game modes for a video game that user the user plays (e.g., Player vs Player game modes or Player vs Environment game modes); 7) data on whether the user or account for a given game has downloaded or purchased any additional content for the game (e.g., downloadable content); 8) whether the user or account for a given game has made any in-game purchases for the game (e.g., to purchase virtual currency, items, or the like); 9) a length of time to complete levels or otherwise advance within the video game (e.g., the first level, 1-1, of Super Mario Bros or the first dungeon in The Legend of Zelda), 10) a number of deaths or restarts in each game session (or total). Other types of gameplay data may also be stored to database 102. In certain example embodiments, any type of gameplay data that is quantifiable may be stored.

The gameplay data may then be analyzed across other (or all) users to determine where, within the range of users, a particular user falls. This may include, for example, plotting the gameplay data on a scale and determining within which standard deviation the specific user gameplay data falls. As discussed herein, this information allows for the generation of a base rating (also called an initial implicit rating). For example, if the user's gameplay data falls within one standard deviation they may be assigned a base rating of 3 (if a rating scale is 1 to 5). Other techniques may also be used.

In certain example embodiments, the data may be stored in aggregate form within the database 102 (e.g., that a user has played 45 hours) or the data that makes up such aggregated data may be stored (e.g., the stop and start time of each play session is stored in the database 102) and the aggregation may be generated on the fly (e.g., by rating computer system 104).

In certain example embodiments, the data within gameplay meta database may be stored as a plurality of records, with each record being linked to a specific game and/or a specific user. Thus, for example, a record within gameplay metadata database may reference User A, game Y, and a time played value of 45 hours. In other words, in certain example embodiments, a record may include a reference to a specific user, to a specific game, and to one or more pieces of metadata regarding the specific game.

The system shown in FIG. 1 also includes an external services database 103 that may be provided via an example computing device 700 that is described in connection with FIG. 7. In certain example embodiments, database 103 may be part of rating computer system 104. In certain example embodiments, database 103 may be provided via cloud-based computer system such as, for example Amazon's S3 or RDS web services storage or database offerings.

It will be appreciated that the term “database” as used herein covers different techniques for organizing, collecting, or storing data on a computer system. In certain examples, one or both of the databases discussed herein may be implemented in, for example, a relational database system. In certain examples, one or both of the databases discussed herein may be implemented in, for example, as a flat file. In certain examples, one of both of the databases discussed herein may be an object-oriented database or may be stored in volatile memory or non-volatile memory. In certain example embodiments, one or both of the database discussed herein may be implemented using NoSQL or be using XML files. In certain example embodiments, one of both of the databases may include multiple separate database that make up database 102 or 103. For example, different databases may be used to store gameplay data for different games. Or different database may be used to store external data.

External services database 103 stores external data regarding video games. Data from external sources may be organized or split into different categories of external data. A different category may correspond to each of 110, 112, 114, and 116. As explained in greater detail below, each of these external categories may include different sources from which data is obtained (e.g., each user review website being a different source within the same category). As can be appreciated, these external services include information that represents information that is external from the game itself or what can be collected directly from the game. For example, these might be reviews of the game by critics, ratings by users on a retail website, or sentiment information about the game collected from social media.

In certain example embodiments, the data within external services database 103 may be stored as a plurality of records, with each record being linked to data for a specific external source and/or external category along with a specific video game. Thus, for example, database 103 may store a record that a critic, which is part of the critic category, gave game X a rating of 9.5. In certain examples, the average rating for a given external category (e.g., as opposed to the individual sources for a category) is stored in database 103. Thus, a critic's category rating (which may or may not be modified by the weighting as discussed in connection with calculating the average external rating in step 508 of FIG. 5) may be stored instead of individual critic scores. In certain example embodiments, the output of 510, 512, 514, and/or 516 from FIG. 5 (e.g., plural external ratings) may be stored to database 103. In certain example embodiments, the input data for 510, 512, 514, and/or 516 may be stored to database 103.

The external data may include a category for user review data that is obtained from external user reviews service 110. External data may include a category for data of reviews of video games from critics or other professional entities. Critic data may be obtained via critic service 112. The external data may include a category for social media data for video games. This data may be obtained from social media services 114. The external data may include a category for sales and/or ownership data for video games. This data may be obtained from sales/ownership database 116 or another service that provides such data. In certain example embodiments, different sales and ownership databases may be used and be in their own categories. For example, one external source may have ownership data for game X and another may have sales data for game X.

In certain example embodiments, only one of the categories discussed herein may be used for calculating an external rating (e.g., as discussed in connection with 508 in FIG. 5). For example, only the sales/ownership category of data may be used. Such implementations may be advantageous as the data for calculation of the external rating may only come from one source and may thus be easier to implement. In certain examples, additional categories of external data may be used as described herein. In certain examples, additional data categories (or data sources within such categories) may be added as they become available.

Each of external user reviews service 110, critic service 112, social media services 114, and sales/ownership database 116 may include a software module or the like that executes on an example computing device 700 (e.g., rating system 104) that is described in connection with FIG. 7 to acquire the data associated with each module.

External user reviews service 110 may include or be a service or software module that accesses or obtains user reviews (or aggregates thereof) of video games from various different web sites (e.g., different external sources). This may include user ratings of video games from websites such as Metacritic, Steam, Best Buy, GameStop, Amazon, or other web sites that show (or otherwise store) how users have rated video games. In certain example embodiments, the average rating (which may be converted into a standard scale from the scale used on the individual website) from each website or service is acquired and the number of user reviews on that web site for that average is stored. These two data points (along with the source of the reviews and other data as desired) for a given game are then stored into external services database 103. In certain example embodiments, individual user reviews may be stored into database 103 along with the source (e.g., Amazon, Steam, etc. . . . ) of that review.

As used herein, the term average includes calculation or a mean, median, mode, mid-range, and the like. Calculating an average includes applying weights, truncating calculated values, and other techniques. Average includes techniques for calculating a value or dataset from a plurality of values or datasets.

Critic service 112 may include or be a service or software module that accesses or obtains the ratings for video games given by critics. In certain instances, this data may be obtained directly from the website or other system used by the critic. In certain examples, an aggregator site, such as Metacritic, may be used to obtain the ratings given to a game by critics. The ratings given by critics may be converted into a standardized scale. Thus, for example, one critic's “A” may be translated into 95 (or 100), while another critic's score of 5 (out of 5) may be translated into a 100.

In certain example embodiments, the critic service 112 may extract or derive a rating score based on sentiment analysis of the textual review of the game in question. Such an implementation may be used in, for example, cases where no quantitative score is provided by the critic review. For example, keywords or the like may be extracted from the review and used to generate a critic score for that game. Words or phrases like “excellent” “masterpiece,” “critical hit” may be associated or tend to a higher score. In contrast, words or phrases like “not exceptional,” “not enjoyable” may tend towards a lower score.

In certain example embodiments, the output that is provided to the database 103 may include the name (or ID) of the critic in question, a score, and the video game for which the score is given. Additional data such as the date of the review or the like may also be included.

Social media service 114 may include or be a service or software module that accesses or obtains data regarding video games from social media, streaming sites, and similar platforms. Such data may include, for example, a number of tweets associated with the video game and sentiment analysis that can provide data indicating whether such activity is positive or negative. In certain example embodiments, streaming data may include the most watched games (e.g., the number of viewers of streams for a video game) and/or the number of streamers for a given video game. Other data related to streaming may also be included, for example, peak viewer/streamer count. Such information may be used to quantify which games are trending and/or how popular such games are. The data acquired by social media service 114 may be stored to external services database 103.

Sales/Ownership database 116 may include or be a service or software module that accesses or obtains sales and/or ownership data for games. In certain example embodiments, this data may be obtained directly from retailers (electronic and/or brick and mortar), the publisher or developer of the game, the entity that runs the gaming system that the game is sold for (e.g., the manufacture of a video game console), or an entity that runs a gaming service (e.g., Discord). In certain example embodiments, the sales and/or ownership data may include activation or registration data. Such information may be useful because certain games that are bought may not have been used and/or used on computing devices with no external network access (and thus no report of the game being played may be generated). The data acquired by sales/ownership database 116 may be stored to external services database 103.

The data stored in databases 102 and 103 may be supplied to the rating computer system 104. Rating computer system 104 is an example of computing device 700 that is described in connection with FIG. 7. In certain example embodiments, rating system 104 includes one or more computing devices 700. For example, the rating system may include multiple computing devices 700 that form a server computer system or the like. In certain example embodiments, rating system 104 is provided within a cloud-computing infrastructure whereby processing resources (e.g., CPU, memory, I/O, etc. . . . ) may be allocated statically or dynamically to carry out the functionality provided by rating system 104.

Rating system 104 includes a base rating module 106, an external game rating module 108, and an adjustment factor module 118 that all function to generate a given user's implicit 120 rating for a video game.

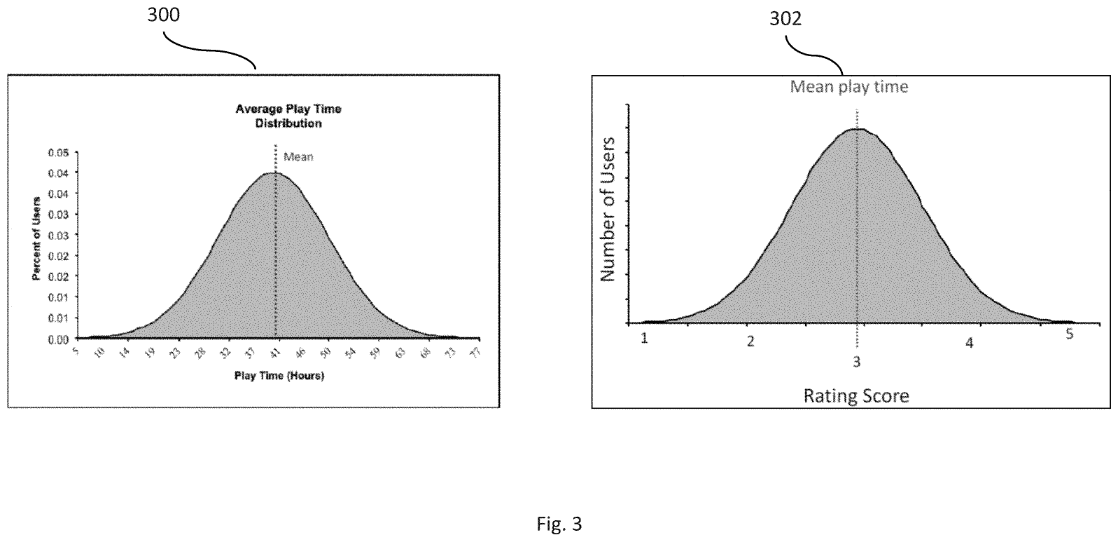

The base rating module 106 calculates an initial base rating for a given user and video game. In other words, base rating=f(user, game). This rating is based on both the user's individual gameplay data and calculated averages for how other (e.g., all) users have played the video game. In certain examples, this may be thought of as an initially calculated user specific implicit rating for a video game (which is then further modified according to the techniques described herein). Base rating module 106 thus determines where, on a given rating distribution for a specific video game (e.g., as shown in FIG. 3), the user's base rating will fall. The specific techniques for how such values are calculated are discussed in connection with FIG. 5. The base rating module may perform this functionality for each user that has played a video game (to thereby generate an implicit rating of that video game for each user). The calculated base ratings are then supplied to the adjustment factor module 118 that is discussed in greater detail below.

External game rating module 108 calculates an average rating for a game with the data collected from the external sources (which is stored into database 103). As discussed in greater detail below, the various sources (and/or the categories for those source) of data may be weighted when this calculation is performed. In certain example embodiments, the external game rating may be on the same rating scale as the base rating calculated from base rating module 106 (e.g., both on a scale of 1 to 5). In other examples, the ratings may be on different scales (e.g., one is on a scale of 1 to 5 and another is on a scale of 1 to 100). In any event, the external game rating is provided to the adjustment factor module 118.

The adjustment factor module 118 may be used to calculate an average base rating (e.g., based off all of the users for which a base rating was calculated for a given video game) and then generate an adjustment factor based on the average base rating and the average external game rating provided from module 108. This generated adjustment factor may then be combined with an individual user's base rating to thereby derive the user implicit rating 120.

In certain example embodiments, the derived user implicit rating 120 may be stored to memory (e.g., memory devices 704) in a database or the like as the rating for the specific user and specific game. In other words, implicitRating=f(game, user).

The user's implicit rating may then be used as input for other computer systems and/or processes that are executed by such computer systems. For example, the user's implicit (or multiple such implicit ratings for which the user has played) rating may be used to find or recommend other games. Such games may then be presented to the user via, for example, graphical user interface of an online store, via a message (e.g., an email or SMS/text message) or the like. Such recommendations may be personalized to the user in question due to the technique by which the implicit rating(s) for that user have been generated

In certain example embodiments, the user implicit rating 120 may be stored and used at a later date, and then days, weeks, months, or even years later the already calculated user implicit rating 120 may be used as input for a game recommendation process. For example, user A may play game X for a certain period of time and then stop playing the game (or may stop playing games altogether). At a later time (e.g., when the user desires to have a game recommendation provided) the calculated user implicit rating 120 may be retrieved from memory and then used as input for a game recommendation process. In certain example embodiments, user implicit rating 120 may be generated in conjunction with the video game recommendation process. In other words, user A may request video game recommendations (or some other process or even may trigger video game recommendations for user A) and the process described herein for generating implicit rating 120 may be triggered. In certain example embodiments, the generation of multiple implicit game ratings for video games that have been played by the user may be performed in parallel.

In certain example embodiments, multiple different implicit ratings 120 for different video games may be generated for the same user. The multiple different implicit ratings for the same user may then be used, in combination, as input to generate video game recommendations for that user that may, for example, use conventional recommendation techniques.

### Description of FIGS. 2-4B

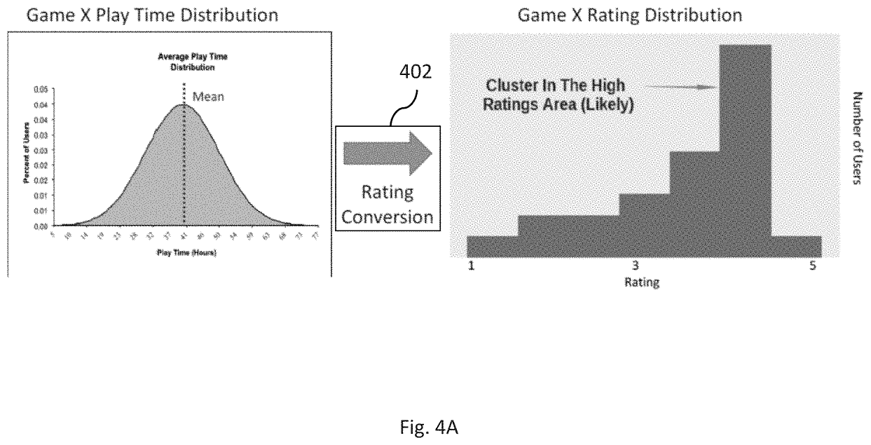

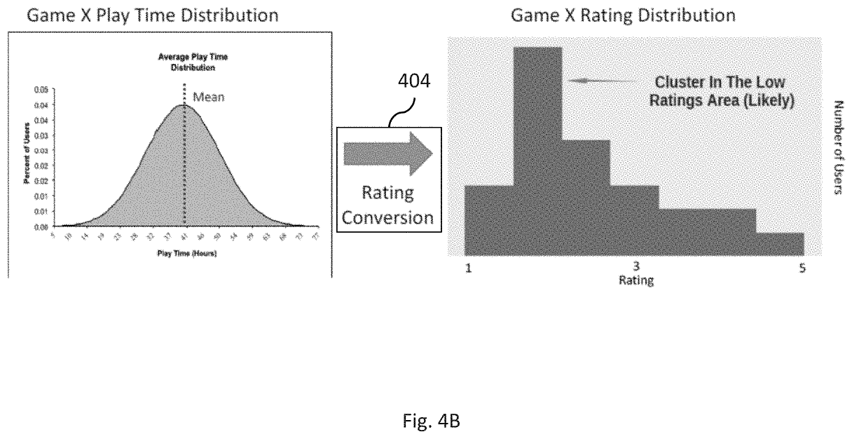

FIGS. 2-4B include graphs that illustrate various aspects of certain example embodiments. FIG. 2 includes multiple graphs that illustrate different possible distributions for how video games may be rated according to certain example embodiments. FIG. 3 is a graph that illustrates average playtime for an example game according to certain example embodiments. FIGS. 4A and 4B include graphs that illustrate different relationships for how play time distribution may be converted into a rating distribution.

Looking to FIG. 2, graph 202 illustrates an example rating distribution for a game that may be rated as “great game” by users. As shown in graph 202, the rating distribution is shifted towards the higher end of the scale with the majority of users rating the game better than “average.” In other words, ratings for the game may cluster towards the higher end of a rating scale.

Graph 204 illustrates an example rating distribution for a game that may be rated “average” by users. As shown in graph 204, the rating distribution is evenly balanced, with a majority of users rating the game as “average” (e.g., between 4 and 6 on a scale of 1-10). In other words, ratings for the game may cluster towards the middle of the rating scale.

Graph 206 illustrates an example rating distribution for a game that may be rated “bad” by users. As shown in graph 206, the rating distribution is shifted towards the lower end of the rating scale, with a majority of users rating the game below average (e.g., between 1 and 3 on a scale of 1-10). In other words, ratings for the game may cluster towards the lower end of a rating scale.

Graph 208 illustrates an example rating distribution for a game with no prominent clusters. This type of rating distribution for video games is unlikely to occur, but may occur in certain situations. As shown in graph 208 the rating distribution is evenly balanced across the rating spectrum with no particular majorities existing within the distribution.

Other example distributions are also possible, for example some games may have a rating distribution with clusters on the lower end and clusters on the higher end with relatively few ratings in the middle.

FIG. 3 includes a graph 300 that illustrates the average playtime for an example game according to certain example embodiments. As discussed herein, data regarding user playtime (and other gameplay data) of video games may be stored to a game play database and FIG. 3 provides an illustrative example for how play time for an example video game may be distributed. In graph 300, play time for an example ranges from 5 to 77 hours. In certain examples, a given distribution for playtime for a video game may be constructed based on records that have playtime above a certain value (e.g., 5). In certain examples, users that are in the bottom x % (where x is between 0 and 5, for example) of playtime may be excluded.

In certain instances, the average playtime distribution in graph 300 may be converted into a corresponding average rating for the video game on a score of 1 to 5. For example, 1 may correspond to the lowest score a user could give the game while 5 corresponds to the highest score.

It will be appreciated that while the graph 300 may show a relatively even distribution, that the game itself may be bad (or good) and thus the rating conversion 302 may incorrectly model the rating distribution for that game. Accordingly, a rating conversion may be used according to certain example embodiments. FIGS. 4A and 4B provide two different examples for how the same average playtime distribution dataset (300 in FIG. 3) may be converted into different rating distributions by using different rating conversions.

FIG. 4A provides an example illustration for how rating conversion 402 may be used in combination with the dataset represented by graph 300 to generate a dataset for ratings as illustrated in graph 202. In particular, rating conversion 402 uses data that is reflective a “good” game to then generate a rating distribution as shown in graph 202. In certain example embodiments, data that is reflective a “good” game may be acquired from external third-party sources (e.g., reviews, critics, social media, sales, and the like).

FIG. 4B provides an example illustration for how rating conversion 404 may be used in combination with the dataset represented by graph 300 to generate a dataset for ratings as illustrated in graph 206. In particular, rating conversion 404 uses data that is reflective a “bad” game to then generate a rating distribution as shown in graph 206. In certain example embodiments, data that is reflective a “bad” game may be acquired from external third-party sources (e.g., reviews, critics, social media, sales, and the like).

### Description of FIG. 5

FIG. 5 shows an example process that may be implemented on the rating system of FIG. 1 and can be used to generate a user specific implicit rating for a video game according to certain example embodiments.

In 502, gameplay data is obtained in connection with users. In certain example embodiments, this may involve periodically receiving gameplay data about how users are playing the various video games on computing devices 100. In certain examples, such data may be stored on a server system and may be periodically provided to rating system 104 and/or stored to database 102. As discussed above, the gameplay data may include, for example, the amount of time each user has played a given video game, how many sessions that have been played, the length of play sessions, etc.

In 504, a community average for gameplay data is calculated. This may involve summing the selected gameplay data for a video game and then dividing by the total number of users for which there is data. In the example process in FIG. 5, the playtime for each user is the selected gameplay data and thus at 504, the average playtime by the community of users (e.g. all users for which data is stored into database 102) is calculated. For example, the mean average may be calculated as follows: playtime_avg_community (game x)=(playtime_user1 (game x)+playtime_user2 (game x)+ . . . +playtime_userN (game x))/(total_number_users). In certain example embodiments, the community average may be stored at this point and used (e.g., without recalculating) for future implicit rating calculations.

In certain example embodiments, all players that have played a given video game may include as part of the community data. In certain example embodiments, the community data may be constructed as a representative sample. In certain example embodiments, the data set for the “community” may be selected randomly or may otherwise include less than all of the users for which gameplay data has been collected.

Next, at 506, the base rating score for each user is calculated. The calculation of the base rating score for each user takes into account the minimum and maximums of the gameplay data. For example, if playtime is used as the game play data, then the minimum and maximum playtime from among all users may be used. An average rating to be associated with the midpoint of the gameplay data may also be used. For example, 41 hours in graph 300 may be midpoint and this may be associated with a rating of “3” (on a scale of 1 to 5).

As noted herein, different types of “averages” may be calculated by using the community (or other representative data). Indeed, the determination of an average may include techniques for determining representative data from a broader data set (e.g., the community of players for a given video game). For example, a standard deviation calculation may be used to classify the different data for the broader community dataset and where an individual user's gameplay data falls within the broader community dataset. The breakdown in standard deviation of the data may then be used to calculate a user's base rating for a game. For example, if the user is within one standard deviation, a midpoint score (e.g., “average”) may be assigned in step 506 as the user's base rating.

The process then compares the gameplay data for each user against the average calculated from 504.

If the user's gameplay data is less than (or equal) to the average, then an offset is calculated based on the difference between the average community gameplay data and the user's gameplay data. This is divided by the different between the average community gameplay data and the minimum gameplay data. This calculated offset is then multiplied by multiplier value and that result is subtracted from the rating midpoint to generate a base rating for the user for a specific video game.

If the user's gameplay data is greater than (or equal) to the average, then an offset is calculated based on the difference between the average community gameplay data and the user's gameplay data. This is divided by the difference between the average community gameplay data and the maximum gameplay data. This calculated offset is then multiplied by a multiplier value and that result is added to the rating midpoint value to generate a base rating for the user for a specific video game.

Example pseudo code for 506 is provided in Table 1 and uses playtime as an example of gameplay data.

TABLE 1
Let

MIN_PLAYTIME (game x) = min { playtime_user1 (game x),
playtime_user2

(game x),...,playtime_userN (game x) }

MAX_PLAYTIME (game x) = max {playtime_user1 (game x),
playtime_user2

(game x),...,playtime_userN (game x) }

RATING_MIDPOINT = 3.0, when playtime equals the mean (i.e.,

playtime_avg_community)

MULTIPLIER = 2.0

# Calculate Base Rating score for each user
IF playtime (user y, game x) LTE playtime_avg_community (game x)
THEN

# playtime is less than or equal to mean; Note: offset has a range of
[0-1]
offset = ( playtime_avg_community (game x) − playtime (user y,
game x) ) / (

playtime_avg_community (game x) − MIN_PLAYTIME (game x) )

base_rating (user y, game x) = RATING_MIDPOINT −
MULTIPLIER * offset

ELSE

offset = ( playtime (user y, game x) − playtime_avg_community
(game x) ) /

(MAX_PLAYTIME (game x) − playtime_avg_community (game x) )
base_rating (user y, game x) = RATING_MIDPOINT + MULTIPLIER *
offset

In 508, the average external rating for a given video game is calculated. This includes calculation of external user ratings at 510, calculation of a sales and/or ownership rating at 512, calculation of a critic rating at 514, and calculation of a social media rating at 516. In certain example embodiments one or more of the sub-steps for 508 may not be included or may be skipped. In certain example embodiments, additional sub-steps for calculation of an average external rating may be included.

In 510, an average game rating is derived based on user ratings provided on external websites or other sources. As discussed above, multiple different sources may provide data for user provided ratings of a given video game. As also discussed above, the data generated based on these external sources may be stored as averages in combination with the total number of ratings for that game from the given source. With this information, at 510, the respective averages may be weighted. Table 2 includes a pseudocode example for this process.

TABLE 2
# Let S1, S2,.., SN be different external sources (e.g., gaming/e-commerce
websites).
# Calculate total number of user reviews by summing user review counts
from all
the sources.
total_user_reviews = S1_num_user_reviews (game x) +
S2_num_user_reviews
(game x) +...+ SN_num_user_reviews( game x)
# Calculate the average game rating by using rating information from each
source and applying a weight, which is a function of the number of user
reviews
from each source vs. the total user reviews (from all the sources).
game_rating_via_websites (game x) = S1_avg_rating (game x) *

S1_num_user_reviews (game x)/total_user_reviews +
S2_avg_rating (game x) * S2_num_user_reviews (game x)/
total_user_reviews + ... +
SN_avg_rating (game x) * SN_num_user_reviews (game x)/
total user reviews

Thus, an average game rating from external user reviews (e.g., a rating for the user reviews category) may be calculated in 510.

In 512, an average game rating using sales and/or ownership data may be calculated. In step 512, the minimum and max sales and/or ownership information among all games is determined. This information may then be used to grade or rank where the sales and/or ownership for a specific game falls (e.g., within which standard deviation). Table 3 includes contains a pseudocode example for this process.

TABLE 3
# Let
MIN_SALES_COUNT = min { SALES_COUNT (game x),
SALES_COUNT
(game y), ... SALES_COUNT (game N)}
MAX_SALES_COUNT = max { SALES_COUNT (game x),
SALES_COUNT
(game y), ... SALES_COUNT (game N)}
# Calculate rating using sales data; range of rating is: [1,5]
game_rating_via_sales_data (game x) = (4 * (sales count (game x) −
MIN_SALES_COUNT) / (MAX_SALES COUNT −
MIN_SALES_COUNT)) + 1

Thus an average game rating for sales or ownership data (e.g., a rating for the sales/ownership category) may be calculated in 512.

In 514, the average rating of critic reviews is calculated. Here, each critic may be assigned a weight (e.g., with the sum of all weights being 1) and used to weight the quantitative review score provided by the critic. Table 4 includes contains a pseudocode example for this process on step 514.

TABLE 4
# Let
C1, C2, ..., CN be game critic reviews from different sources.
CW1, CW2, ..., CWN be the weights for each critic review sources.
CW1 + CW2 +...+ CWN = 1; a critic with more credentials or trust
can be
assigned a higher weight.
game_rating_via_critic_reviews (game x) = C1_rating (game x) *
CW1 +
C2_rating (game x) * CW2+...+ CN_rating (game x) * CWN

Thus an average game rating for critic sources (e.g., a rating for the critic category) may be calculated in 514.

In 516, an average game rating based on social media data may be calculated. In this example, min and max values may be determined based on all other games (or at least plural other games). The social media data for a specific game may be slotted between the min and max values and rated on an example rating scale (e.g., 1 to 5).

The results of 510, 512, 514, and/or 516 may then be used to calculate the average external game rating. In certain example embodiments, each of the sources (e.g., 510, 512, 514, and 516) of the calculated ratings may be weighted (e.g., such that the weights add up to 1). For example, the critic rating average may be weighted higher than the sales average. Thus, a critically acclaimed game may still achieve a higher average external rating if the sales and ownership data is relatively low.

Table 5 includes contains a pseudocode example for this process that is performed in 508.

TABLE 5
average_ext_rating (game x) = function {Gaming/e-commerce websites,
Game
sales data, Game critic reviews, Social media data}
= rating (game rating websites) * weight1 + rating (games sales data) *
weight2
+ rating (game critic reviews) * weight3 + rating (social media data) *
weight4
where,

weight1 + weight2 + weight3 + weight4 = 1
average_ext_rating = [1, 5]

Thus an average external game rating may be calculated in 508. In certain examples, the external rating calculated via 508 may be based on data from only one of the external data categories (e.g., the sale/ownership data or critic ratings). In certain example embodiments, each of the data sources for a given category may be separately weighted. Thus, for example, if two data sources are used for a sales/ownership rating (e.g., one based on sales and one based on ownership), then the two data sources for that rating may be weighted differently in determining the rating for the sale/ownership category. In certain example embodiments, each of the categories may be weighted when calculating the external rating via 508.

In 518, the base rating scores for each user calculated in step 506 may be used to calculate an average base rating score. For example, average_base_rating (game x)=base_rating_user1 (game x)+base_rating_user2 (game x)+ . . . +base_rating_userN (game x))/(total_number_users).

In 520, an adjustment factor is calculated by taking the difference between the average external rating calculated in 508 from the average base rating calculated in 518.

In 522, the implicit rating for given video game for a given user is calculated by adding the base rating for that user for the video game (calculated at 506) to the adjustment factor calculated at 520. For example, “rating(user y, game x)=base_rating (user y, game x)+adjustment_factor (game x).” This results in an implicitly generated rating of a given video game for a given user. In certain instances, this preliminary result may be clipped to keep the final rating within a predefined bounds (e.g., between 1 and 5).

Thus, when the adjustment factor from 520 is positive the implicitly generated rating will be higher for this user than it otherwise would have been. For example, the middle graph in FIG. 6 shows what occurs if no adjustment factor is used (or if the adjustment factor is zero). This results in the graph shown in FIG. 3. Meanwhile, an adjustment factor that is positive (greater than 0) may then result in a standard rating distribution being shifted towards higher ratings (as shown on the top graph of FIG. 6). In contrast, an adjustment factor that is negative (less than 0) may then result in a standard rating distribution being shifted towards lower ratings (as shown on the bottom graph of FIG. 6).

As discussed herein, such automatically generated implicit ratings that are specific to both users and video games may then be used as input for other processes, such as conventional recommendation systems.

### Example Execution

The following example data is used to show how the process in FIG. 5 may operate.

The data, which is total playtime by user, that is collected according to step 502 (e.g., the initial data) is shown in table 6.

TABLE 6
Data: Total playtime (in minutes) for the following users for Game X
User 1: 30
User 2: 1000
User 3: 200
User 4: 75
User 5: 150
User 6: 700
User 7: 1200
User 8: 500
User 9: 425
User 10: 110

Next, the playtime data is average to obtain a community average. Specifically, in 504, the community average playtime of a game (e.g., the mean) is calculated using the playtime of all users as is shown in Table 7.

TABLE 7

playtime avg community (game x) =
(30+1000+200+75+150+700+1200+500+
425+110)/10 = 439

Next the base rating score, per 506, is calculated as is shown in Table 8 below.

TABLE 8
base_rating (user 1, game x) = 3 − 2 * (439−30) /(439-30) = 1
base_rating (user 2, game x) = 3 + 2 * (1000−439) /(1200-439) = 4.47
base_rating (user 3, game x) = 3 − 2 * (439−200) /(439-30) = 1.83
base_rating (user 4, game x) = 3 − 2 * (439−75)/(439-30) = 1.22
base_rating (user 5, game x) = 3 − 2 * (439−150)/(439-30) = 1.59
base_rating (user 6, game x) = 3 + 2 * (700−439)/(1200-439) = 3.34
base_rating (user 7, game x) = 3 + 2 * (1200−439)/(1200-439) = 5
base_rating (user 8, game x) = 3 + 2 * (500−439)/(1200-439) = 3.08
base_rating (user 9, game x) = 3 − 2 * (439−425)/(439-30) = 2.97
base rating( user 10, game x) = 3 − 2 * (439−110)/(439-30) = 2.20

Next, per 510, the average rating based on user reviews from external sources is calculated as shown in Table 9. This results in an average of 4.55.

TABLE 9
Game X
Site 1: avg user rating - 4.48; number of user ratings = 1305
Site 2: avg user rating - 4.29; number of user ratings = 300
Site 3: avg user rating - 4.60; number of user ratings = 3000
total_user_reviews = 1305 + 300 + 3000 = 4605
game_rating_via_websites (game x) = (4.48 * 1305/4605) + (4.29 *
300/4605) +
(4.60 * 3000/4605) = 4.55

Next, per 512, the average rating based on sales data is calculated as shown in Table 10. This results in an average of 4.20.

TABLE 10

Game X
Sales count = 320,000
MIN_SALES_COUNT = 100
MAX_SALES_COUNT = 400,000
game_rating_via_sales_data (game x) = 4 * (320,000− 100/
400,000−100) + 1 =
4.20

Next, per 514, the average rating based on critic review sources is calculated as shown in Table 11. This results in an average of 4.35.

TABLE 11
Game X
Critic Site 1 rating - 8.8 (8.8/10 *5 = 4.4)
Metacritic critic rating - 85% (82/100 * 5 = 4.1)
Independent Critic Rating 1 - 9.5 (9.5/10 * 5 = 4.75)
# Let Critic Site 1 = 0.4; METACRITIC_WEIGHT = 0.4; Independent
Critic Rating
1 = 0.2
game_rating_via_critic_reviews (game x) = 4.4 * 0.4 + 4.1 * 0.4 + 4.75
* 0.2 =
4.35

Next, per 508, the average external rating is calculated as shown in Table 11. This results in an average external rating of 4.42.

TABLE 12
# Let Weight1 = 0.55, Weight2 = 0.25, and Weight3= 0.20
average_ext_rating (game x) = game_rating_via_websites (game x) *
WEIGHT1
+ game_rating_via_sales_data (game x) * WEIGHT2 +
game_rating_via_critic_reviews (game x) * WEIGHT3
= 4.55 * 0.55 + 4.20 * 0.25 + 4.35 * 0.20
= 4.42

Next the average base rating, per 518, and adjustment factor, per 520, are calculated as shown in Table 13. This results in an average base rating of 2.67 and an adjustment factor of 1.75.

TABLE 13
# Calculate the average base rating of a game
average_base_rating (game x) = (1 + 4.47 + 1.83 + 1.22 + 1.59 + 3.34 +
5 +
3.08 + 2.97 + 2.20) / 10 = 2.67
# Calculate the adjustment factor
adjustment_factor (game x) = 4.42 = 2.67 = 1.75

Next, per 522, the final implicit rating values for the users are calculated as shown in Table 14.

TABLE 14

# clip the final value as needed such that the range is from [1,5]
rating (user 1, game x) = 1 + 1.75 = 2.75
rating (user 2, game x) = 4.47 + 1.75 = 6.22 -->clip to--> 5.0
rating (user 3, game x) = 1.83 + 1.75 = 3.58
rating (user 4, game x) = 1.22 + 1.75 = 2.97
rating (user 5, game x) = 1.59 + 1.75 = 3.34
rating (user 6, game x) = 3.34 + 1.75 = 5.09 -->clip to--> 5.0
rating (user 7, game x) = 5 + 1.75 = 6.75 -->clip to--> 5.0
rating (user 8, game x) = 3.08 + 1.75 = 4.83
rating (user 9, game x) = 2.97 + 1.75 = 4.72
rating( user 10, game x) = 2.20 + 1.75 = 3.95

### Description of FIG. 7

FIG. 7 is a block diagram of an example computing device 700 (which may also be referred to, for example, as a “computing device,” “computer system,” or “computing system”) according to some embodiments. In some embodiments, the computing device 700 includes one or more of the following: one or more processors 702; one or more memory devices 704; one or more network interface devices 706; one or more display interfaces 708; and one or more user input adapters 710. Additionally, in some embodiments, the computing device 700 is connected to or includes one or more display devices 712. Additionally, in some embodiments, the computing device 700 is connected to or includes one or more input devices 714. In some embodiments, computing device 700 may be connected to one or more external devices 716. As will be explained below, these elements (e.g., the processors 702, memory devices 704, network interface devices 706, display interfaces 708, user input adapters 710, display devices 712, input devices 714, external devices 716) are hardware devices (for example, electronic circuits or combinations of circuits) that are configured to perform various different functions for and/or in conjunction with the computing device 700.

In some embodiments, each or any of the processors 702 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes, for example, a CPU, a GPU, and other hardware components such as memory and/or a memory controller (e.g., Northbridge), I/O controller (e.g., Southbridge), networking interfaces, and the like). In some embodiments, each or any of the processors 702 uses an instruction set architecture such as x86 or Advanced RISC Machine (ARM). In some embodiments, each or any of the processors 702 is or includes, for example, a graphical processing unit (GPU), which may be an electronic circuit designed to generate images and the like.

In some embodiments, each or any of the memory devices 704 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions that may be executed by one or more of the processors 702), or other type of device that performs the volatile or non-volatile storage of data and/or instructions (e.g., software that is executed on or by processors 702). Memory devices 704 are an example of non-transitory computer-readable storage.

In some embodiments, each or any of the network interface devices 706 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (e.g., IEEE 802.11), GSM, CDMA2000, UMTS, LTE, LTE-Advanced (LTE-A), and/or other short-range (e.g., Bluetooth Low Energy, RFID), mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some embodiments, each or any of the display interfaces 708 is or includes one or more circuits that receive data from the processors 702 (e.g., via a discrete GPU, an integrated GPU, a CPU executing graphical processing, or the like) that are used to generate corresponding image data based on the received data, and/or output (e.g., a High-Definition Multimedia Interface (HDMI), a DisplayPort Interface, a Video Graphics Array (VGA) interface, a Digital Video Interface (DVI), or the like) the generated image data to the display device 712, which displays the image data thereon. Alternatively or additionally, in some embodiments, each or any of the display interfaces 708 is or includes, for example, a video card, video adapter, or graphics processing unit (GPU). In other words, the each or any of the display interfaces 708 may include a processor therein that is used to generate image data. The generation or such images may occur in conjunction with processing performed by one or more of the processors 702

In some embodiments, each or any of the user input adapters 710 is or includes one or more circuits that receive and process user input data from one or more user input devices (714) that are included in, attached to, or otherwise in communication with the computing device 700, and that output data based on the received input data to the processors 702. Alternatively or additionally, in some embodiments each or any of the user input adapters 710 is or includes, for example, a PS/2 interface, a USB interface, a touchscreen controller, or the like; and/or the user input adapters 710 facilitates input from user input devices 714.

In some embodiments, the display device 712 may be a Liquid Crystal Display (LCD) display, Light Emitting Diode (LED) display, or other type of display device. In embodiments where the display device 712 is a component of the computing device 700 (e.g., the computing device and the display device are included in a unified housing), the display device 712 may be a touchscreen display or non-touchscreen display. In embodiments where the display device 712 is connected to the computing device 700 (e.g., is external to the computing device 700 and communicates with the computing device 700 via a wire and/or via wireless communication technology), the display device 712 is, for example, an external monitor, projector, television, display screen, etc. . . . .

In some embodiments, each or any of the input devices 714 is or includes machinery and/or electronics that generates a signal that is provided to the user input adapter(s) 710 in response to physical phenomenon. Examples of inputs devices 714 include, for example, a keyboard, a mouse, a trackpad, a touchscreen, a button, a joystick, a sensor (e.g., an acceleration sensor, a gyro sensor, a temperature sensor, and the like). In some examples, one or more input devices 714 generate signals that are provided in response to a user providing an input—for example, by pressing a button or actuating a joystick. In other examples, one or more input devices generate signals based on sensed physical quantities (e.g., such as force, temperature, etc. . . . ). In some embodiments, each or any of the input devices 714 is a component of the computing device (for example, a button is provide on a housing that includes the processors 702, memory devices 704, network interface devices 706, display interfaces 708, user input adapters 710, and the like).

In some embodiments, each or any of the external device(s) 716 includes further computing devices (e.g., other instances of computing device 700) that communicate with computing device 700. Examples may include a server computer, a client computer system, a mobile computing device, a cloud-based computer system, a computing node, an Internet of Things (IoT) device, etc. . . . that all may communicate with computing device 700. In general, external devices(s) 716 may include devices that communicate (e.g., electronically) with computing device 700. As an example, computing device 700 may be a game device that communicates over the Internet with a server computer system that is an example of external device 716. Conversely, computing device 700 may be a server computer system that communicates with a game device that is an example external device 716.

In various embodiments, the computing device 700 includes one, or two, or three, four, or more of each or any of the above-mentioned elements (e.g., the processor(s) 702, memory device(s) 704, network interface device(s) 706, display interface(s) 708, user input adapter(s) 710, display device(s) 712, input device(s) 714). Alternatively or additionally, in some embodiments, the computing device 700 includes one or more of: a processing system that includes the processors 702; a memory or storage system that includes the memory devices 704; and a network interface system that includes the network interface devices 706.

The computing device 700 may be arranged, in various embodiments, in many different ways. As just one example, the computing device 700 may be arranged such that the processors 702 include: a multi (or single)-core processor; a first network interface device (which implements, for example, WiFi, Bluetooth, NFC, etc. . . . ); a second network interface device that implements one or more cellular communication technologies (e.g., 3G, 4G LTE, CDMA, etc. . . . ); memory or storage devices (e.g., RAM, flash memory, or a hard disk). The processor, the first network interface device, the second network interface device, and the memory devices may be integrated as part of the same SOC (e.g., one integrated circuit chip). As another example, the computing device 700 may be arranged such that: the processors 702 include two, three, four, five, or more multi-core processors; the network interface devices 706 include a first network interface device that implements Ethernet and a second network interface device that implements WiFi and/or Bluetooth; and the memory devices 704 include a RAM and a flash memory or hard disk. As another example, the computing device 700 may include a SoC with one or processors 702, plural network interface devices 706, memory devices 704 that include system memory and memory for application programs and other software, a display interface 708 that is configured to output a video signal, a display device 712 that is integrated to a housing with the mentioned and layered with a touch screen input device 714, and multiple input device 714 such as one or more joysticks, one or more buttons, and one or more sensors.

As previously noted, whenever it is described in this document that a software module or software process performs any action, the action is in actuality performed by underlying hardware elements according to the instructions that comprise the software module. Consistent with the foregoing, in various embodiments, each or any combination of the user device 100a, user device 100b, user device 100c, user device 100n, gameplay metadata database 102, rating system 104, external services database 103, base rating module 106, external game rating module 108, adjustment factor module 118, external user reviews service 110, critic service 112, social media service 114, sales/ownership database 116, etc., each of which will be referred to individually for clarity as a “component” for the remainder of this paragraph, are implemented using an example of the computing device 700 of FIG. 5. In such embodiments, the following applies for each component: (a) the elements of the 700 computing device 700 shown in FIG. 7 (i.e., the one or more processors 702, one or more memory devices 704, one or more network interface devices 706, one or more display interfaces 708, and one or more user input adapters 710), or appropriate combinations or subsets of the foregoing, with or without the one or more display devices 712, one or more input devices 714, and/or external devices 716) are configured to, adapted to, and/or programmed to implement each or any combination of the actions, activities, or features described herein as performed by the component and/or by any software modules described herein as included within the component; (b) alternatively or additionally, to the extent it is described herein that one or more software modules exist within the component, in some embodiments, such software modules (as well as any data described herein as handled and/or used by the software modules) are stored in the memory devices 704 (e.g., in various embodiments, in a volatile memory device such as a RAM or an instruction register and/or in a non-volatile memory device such as a flash memory or hard disk) and all actions described herein as performed by the software modules are performed by the processors 702 in conjunction with, as appropriate, the other elements in and/or connected to the computing device 700 (e.g., the network interface devices 706, display interfaces 708, user input adapters 710, display device(s) 712, input device(s) 714, and/or external device(s) 716); (c) alternatively or additionally, to the extent it is described herein that the component processes and/or otherwise handles data, in some embodiments, such data is stored in the memory devices 704 (e.g., in some embodiments, in a volatile memory device such as a RAM and/or in a non-volatile memory device such as a flash memory or hard disk) and/or is processed/handled by the processors 702 in conjunction, as appropriate, the other elements in and/or connected to the computing device 700 (e.g., the network interface devices 706, display interfaces 708, user input adapters 710, display device 712, input device(s) 714, and/or external device(s) 716); (d) alternatively or additionally, in some embodiments, the memory devices 702 store instructions that, when executed by the processors 702, cause the processors 702 to perform, in conjunction with, as appropriate, the other elements in and/or connected to the computing device 700 (e.g., the memory devices 704, network interface devices 706, display interfaces 708, user input adapters 710, display device(s) 712, input device(s) 714, and/or external device(s) 716), each or any combination of actions described herein as performed by the component and/or by any software modules described herein as included within the component.

The hardware configurations shown in FIG. 7 and described above are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIG. 7, (e) via other hardware arrangements, architectures, and configurations, and/or via combinations of the technology described in (a) through (e).

### Technical Advantages of Described Subject Matter

While some user's do provide explicit ratings for video games, many do not. It can thus can be difficult to know if a user likes (or liked) a given game or not. Individual gameplay data can provide some information, but vast differences between video games (e.g., genres), users, how different users play different video games make such data difficult to turn into coherent (and actionable) data. For example, a person may spend hundreds of hours on an adventure game, but only 30 hours on an action game. Does this mean the user like one game and not the other? It is thus a technical problem for how to generate user's specific implicit ratings for video games. Such ratings that may be used as further inputs to, for example, display the rating to the user or provide game recommendations based on such ratings.

In certain example embodiments, user specific gameplay data for individual video games is combined with external data. The external data is used to assist in generating an adjustment factor. The adjustment factor may then be used to a calculated base rating (e.g., an initial rating) for a specific user's use of a video game. This allows for generation of an implicit rating for every (at least all of those for which data is gathered) user that plays a given video game. Such data may then be used to rate or score the individual user's view a given video game. The implicit ratings that are generated for each video game played by a user may then be used as input for generating personalized video game recommendations for that user.

### Selected Terminology

Whenever it is described in this document that a given item is present in “some embodiments,” “various embodiments,” “certain embodiments,” “certain example embodiments, “some example embodiments,” “an exemplary embodiment,” or whenever any other similar language is used, it should be understood that the given item is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments. Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an” and “the” should be read as meaning “at least one,” “one or more,” or the like; the term “example” is used provide examples of the subject under discussion, not an exhaustive or limiting list thereof; the terms “comprise” and “include” (and other conjugations and other variations thereof) specify the presence of the associated listed items but do not preclude the presence or addition of one or more other items; and if an item is described as “optional,” such description should not be understood to indicate that other items are also not optional.

As used herein, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage. The term “non-transitory computer-readable storage medium” does not include a transitory, propagating electromagnetic signal.

### Additional Applications of Described Subject Matter

Although process steps, algorithms or the like, including without limitation with reference to FIG. 5, may be described or claimed in a particular sequential order, such processes may be configured to work in different orders. For example, 518 may be performed before 508. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

1. A computer system for generating implicit, user-specific ratings for video games that are played by users, the computer system comprising:
a non-transitory computer readable storage medium configured to store:
a plurality of gameplay data records that include information about how a plurality of users have interacted with at least a first video game, and
a plurality of external source data records that each correspond to at least one external source that references the first video game;
a processing system that includes at least one hardware processor, the processing system configured to:
generate a community average for the first video game that is based on the plurality of gameplay data records that include information about how each one of the plurality of users has interacted with the first video game;
calculate a base rating for a first user and the first video game as a function of the gameplay data record of the first user and the generated community average;
calculate a plurality of external ratings for the first video game that are each based on at least one of the external source data records;
generate an external average by combining the plurality of external ratings with a plurality of respective weights;
generate an adjustment value that is a function of the generated external average and a generated base rating for the first video game that is based on the plurality of users that have interacted with the first video game; and
derive an implicit rating for the first video game by adjusting, based on the generated adjustment value, the base rating for the first user.

2. The computer system of claim 1, wherein each of the calculated plurality of external ratings is for one of a plurality of different external source categories.

3. The computer system of claim 2, wherein a plurality of different external source categories includes a critic review category, a user review category, and a sale/ownership category.

4. The computer system of claim 2, wherein the plurality of external source data records includes multiple external source data records that correspond to a first category of the plurality of different external source categories, wherein each one of the multiple external source data records corresponds to a different external source of the first category.

5. The computer system of claim 4, wherein each of the multiple external source data records includes a critic review score from one of the different external sources that are within the first category.

6. The computer system of claim 4, wherein each of the multiple external source data records includes a calculated user-based review score that is based on a plurality of user-provided review scores from a corresponding external source.

7. The computer system of claim 6, wherein a user external rating of the calculated plurality of external ratings is based on averaging together the calculated user-based review scores from each of multiple external source data records, wherein each calculated user-based review score is weighted for the averaging based on how many review scores are included in each plurality of user-provided review scores that are from the corresponding external source.

8. The computer system of claim 1, wherein the base rating for the first user is based on determination of a midpoint for the plurality of gameplay data records.

9. The computer system of claim 8, wherein the base rating for the first user is determined to be less than a midpoint on an implicit rating scale when the gameplay data record corresponds to gameplay that is less than the determined midpoint for the plurality of gameplay data records.

10. The computer system of claim 1, wherein each of the plurality of gameplay data records includes data for an amount of time played for the first video game, a number of play sessions for playing the video game, and/or a number of games played by a corresponding user.

11. The computer system of claim 1, wherein the implicit rating is further based on clipping a preliminary implicit rating based on determination that the preliminary implicit rating is outside of a rating range.

12. The computer system of claim 1, wherein the processing system is further configured to:
generate, based on the determined implicit rating, a video game recommendation for a video game that is different from the first video game, wherein the video game recommendation is presented to the first user as part of a graphical user interface.

13. A method for generating implicit, user-specific ratings for video games that are played by users, the method performed on a computer system, the method comprising:
generating a community data set for a first video game that is derived from a plurality of gameplay data records that each include data for how a respective user of a plurality of users have played at least the first video game, the community data set representing how, collectively, the plurality of users have played the first video game;
assigning a base rating that is for a first user of the first video game, the base rating assigned based on assessment of gameplay data for the first user for the first video game relative to other gameplay data in the generated community data set for the first video game;
generating a representative base rating for the plurality of users, the representative base rating being based on the plurality of gameplay data records for the plurality of users;
generating an external rating that is based on plurality of external source data records that each correspond to an external source(s), wherein at least one of the external source(s) is for external data that references the first video game;
generating an adjustment value that is a function of the generated external rating and the representative base rating for the plurality of users; and
calculating an implicit rating for the first video game that is personalized to the first user, the implicit rating calculated by adjusting, based on the generated adjustment value, the base rating for the first user.

14. The method of claim 13, wherein each of the plurality of external source data records is for one of a plurality of different external source categories,
wherein the generated external rating is based on a calculation that includes a plurality of category ratings that each correspond to one of the plurality of different external source categories.

15. The method of claim 14, wherein the plurality of different external source categories includes a critic review category, a user review category, and a sale/ownership category,
wherein the plurality of category ratings includes a critic review category rating, a user review category rating, and a sale/ownership category rating.

16. The method of claim 15, wherein the critic review category rating is based on averaging critic reviews from multiple different external sources.

17. The method of claim 13, further comprising:
generating, based on the calculated implicit rating, a video game recommendation for a video game that is different from the first video game;
causing the video game recommendation to be presented, as part of a graphical user interface, to the first user on a display device that associated with a computing device being used by the first user.

18. The method of claim 13, wherein data for each of the plurality of gameplay data records includes an amount of time played for the first video game, a number of play sessions for playing the video game, and/or a number of games played by a corresponding user.

19. A non-transitory computer readable storage medium storing instructions for use with a computer system, the stored instructions comprising instructions that cause the computer system to:
generate representative community data for a first video game that is derived from a plurality of gameplay data records that each include data for how a respective user of a plurality of users have played at least the first video game, the representative community data representing information about how, collectively, the plurality of users have played the first video game;
determine a base rating to a first user of the first video game, the base rating determined based on gameplay data for the first user for the first video game relative to the representative community data for the first video game;
generate a representative base rating for the plurality of users, the representative base rating being based on the plurality of gameplay data records for the plurality of users;
generate an external rating that is based on plurality of external source data records that each correspond to an external source(s), wherein at least one of the external source(s) is for external data that references the first video game;
generate an adjustment value that is a function of the generated external rating and the representative base rating for the plurality of users; and
calculate an implicit rating for the first video game that is personalized to the first user, the implicit rating calculated by adjusting, based on the generated adjustment value, the base rating for the first user.

20. The non-transitory computer readable storage medium of claim 19, wherein the stored instructions comprise further instructions that cause the computer system to:
generate, based on the calculated implicit rating, a video game recommendation for a video game that is different from the first video game;
cause the video game recommendation to be presented, as part of a graphical user interface, to the first user on a display device that associated with a computing device being used by the first user.
